(19) United States
(12) Patent Application Publication
(10) Pub. No.: US 2006/0266772 A1
(43) Pub. Date: Nov. 30, 2006

(54) Lawn repair device and system

(76) Inventors: James Dean Martin, Lake Stevens, WA (US); James Mattern, East Wenatchee, WA (US)

Correspondence Address: BLACK LOWE & GRAHAM, PLLC, 701 FIFTH AVENUE, SUITE 4800, SEATTLE, WA, 98104, US

(21) Appl. No.: 11/372,753

(22) Filed: Mar. 10, 2006

Related U.S. Application Data
(60) Provisional application No. 60/662,142, filed on Mar. 14, 2005.

(51) Int. Cl. B67D 5/00

(52) U.S. Cl. 222/465.1; 47/1.01 R

(57) ABSTRACT

A lawn repair device and system configured to deliver sand and seed mixtures or other lawn maintenance materials to lawn divots or other lawn defects by tilt activation or piston assist devices that causes the interposing of an aperture beneath a reservoir containing the lawn maintenance materials. The lawn maintenance materials then passes through the aperture and out a channel that aims and confines the lawn maintenance materials to fill a user-selected divot.

### PRIORITY CLAIM

This application incorporates by reference as if fully disclosed herein and claims priority to U.S. Patent Application Ser. No. 60/662,142 filed Mar. 14, 2005.

### FIELD OF THE INVENTION

An embodiment of the present invention relates to a lawn repair device specifically for repairing divots created by golfers.

### BACKGROUND OF THE INVENTION

Divot repair devices have been described by Spring's U.S. Pat. No. 6,637,355 that allows the distribution of sand and grass seed mixtures to divot holes in lawns. The device as taught by Spring, however, requires that it be constantly held and is intended for use by professional lawn maintenance people. Furthermore, the Spring device is limited in that it requires a hand grip activation with linkages to an end-flap attachment, the end-flap attachment allowing passage of the sand and seed mixtures to the divots. The end-flap arrangement taught by Spring is prone to spilling the sand and seed mixtures beyond the divots due to a lack of channelization of the sand and seed mixtures.

### SUMMARY OF THE INVENTION

A lawn repair device and system configured to deliver sand and seed mixtures or other lawn maintenance materials to lawn divots or other lawn defects by tilt activation or piston assist devices that causes the interposing of an aperture beneath a reservoir containing the lawn maintenance materials. The lawn maintenance materials then passes through the aperture and out a channel that aims and confines the lawn maintenance materials to fill a user-selected divot.

### BRIEF DESCRIPTION OF THE DRAWINGS

Illustrative and alternative embodiments of the present invention are described in detail below with reference to the following drawings.

FIG. 1 is an isometric view of a lawn repair device according to an embodiment of the invention in an at rest status;

FIG. 2 is an isometric bottom view of an embodiment of the lawn repair device in an at rest status;

FIG. 3 is an isometric top view of an embodiment of the lawn repair device in an at rest status;

FIG. 4 is another isometric bottom view of an embodiment of the lawn repair device in an at rest status;

FIG. 5 is a side view of an embodiment of the lawn repair device in an at rest status;

FIG. 6 is a side view of an embodiment of the lawn repair device in a deployed status;

FIG. 7 is a side view of an alternate embodiment of the lawn repair device in an at rest status;

FIG. 8 is an isometric view of another alternate embodiment of the lawn repair device in an at rest status;

FIG. 9 is an isometric view of an embodiment of a lawn repair device with a pneumatic assist in an at rest status;

FIG. 10 is an isometric view of an embodiment of a lawn repair device with hydraulic assist in an at rest status;

FIG. 11 is an isometric view of an embodiment of a lawn repair device with an electric assist in an at rest status;

FIG. 12 is a cross-sectional side view of the channel, collimating block and aperture plate region of the aforementioned embodiments of the lawn repair device;

FIG. 13 is an isometric view of an embodiment of a fill hopper for use in conjunction with the aforementioned lawn repair device embodiments;

FIG. 14 is a bottom isometric view of the fill hopper; and

FIG. 15 is an internal top isometric view of the fill hopper.

### DETAILED DESCRIPTION OF THE PARTICULAR EMBODIMENTS

Figures described below illustrate particular embodiments for a lawn repair device and system. Embodiments include lawn repair devices that deliver confined seed and sand mixtures to lawn divots by tilt activation or piston assist devices that do not require tilt activation. The lawn repair devices, through either tilt activation or piston assist, cause the interposing of an aperture beneath a reservoir containing a sand and seed mixture. The sand and seed mixture then passes through the aperture and out a channel that aims and confines the sand and seed mixture to fill a user-selected divot. The system includes a storage chamber configured to charge the reservoir of the lawn repair device with initial and replacement seed and sand mixture lots.

Alternate embodiments include a self-standing lawn repair device that has a tilt-activated trigger to dispense sand and seed mixtures in a confined stream to a divot. The lawn repair device includes a curved sliding shutter aperture that is normally spring-loaded shut in the un-deployed or at-rest state. When the device is tilted, a trigger or plunger is activated and places an aperture beneath a sand and seed reservoir to permit passing of the sand and seed mixtures. The sand and seed mixture transfers through a collimating block, through the aperture and into a channel downstream from the collimating block and aperture. With the collimating block and the channel, the sand and seed mixtures retain a column-like or stream configuration so that a precise aiming and accurate dispensing of the sand and seed mixtures is permitted.

The tilt activation includes a slidable leg that is pivotably engaged with a shutter aperture curve plate, whereupon tilting the slidable leg moves and that movement in turn causes the spring-loaded shutter aperture curve plate to move beneath the reservoir. An aperture is then placed beneath the reservoir and sand and seed mixtures transfer through the aperture. Channelization of the sand and seed mixtures is achieved by the aperture that has a link to develop an initial channel strain, and further more the channel screen is maintained by a channel downstream from the aperture that aims the channelized sand and seed stream into the divots. The amount of channelized sand and seed stream that is delivered to the divots is controlled by the length of time the trigger is maintained in an engaged state.

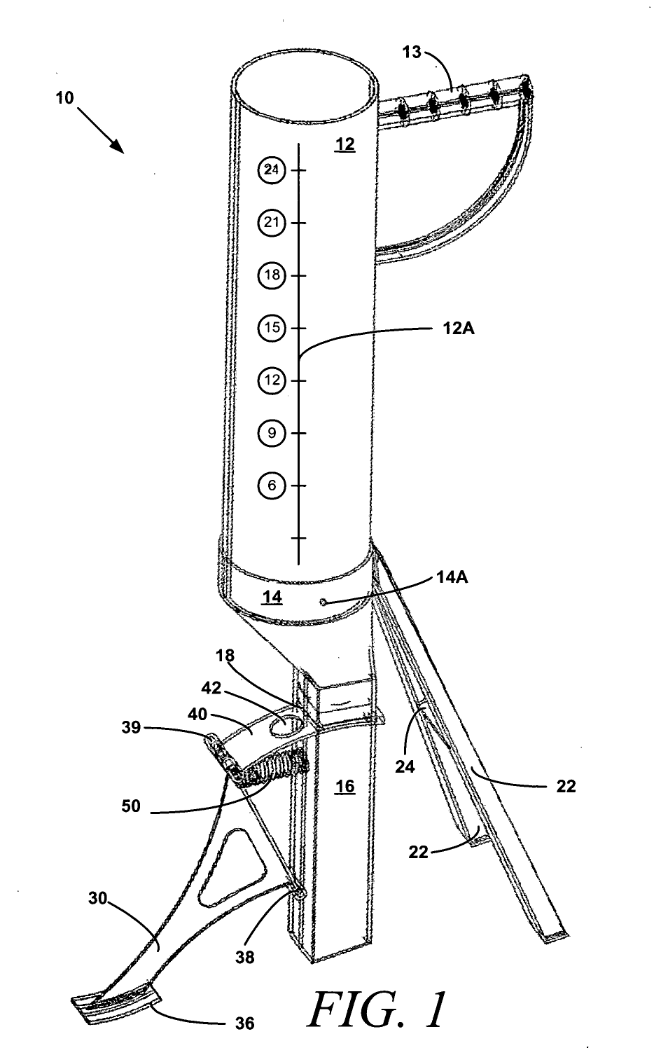

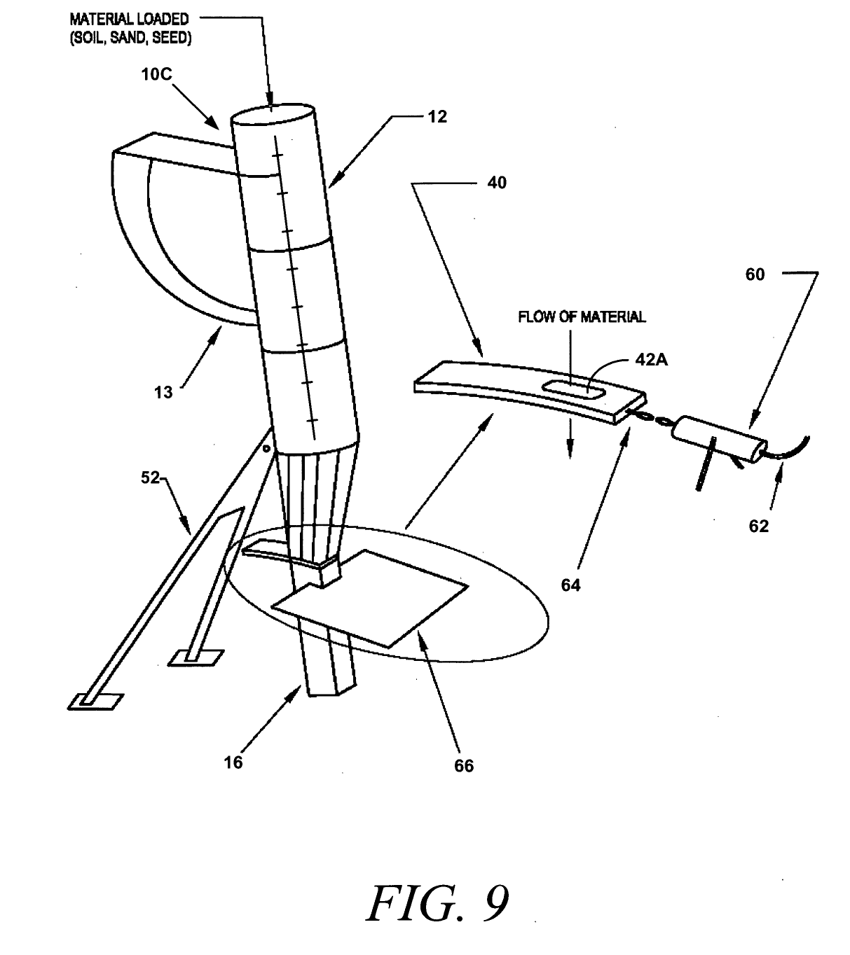

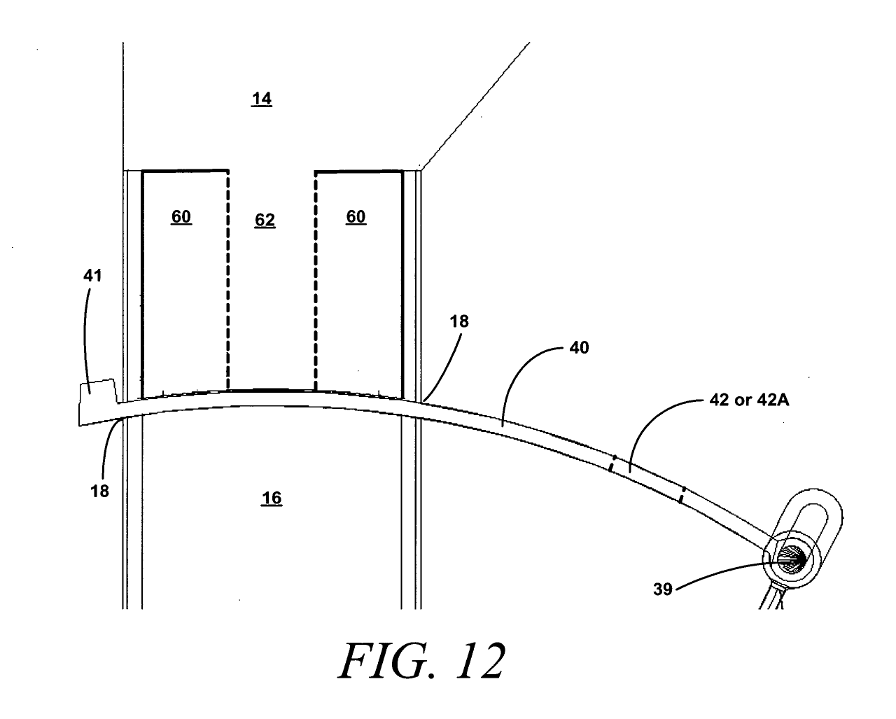

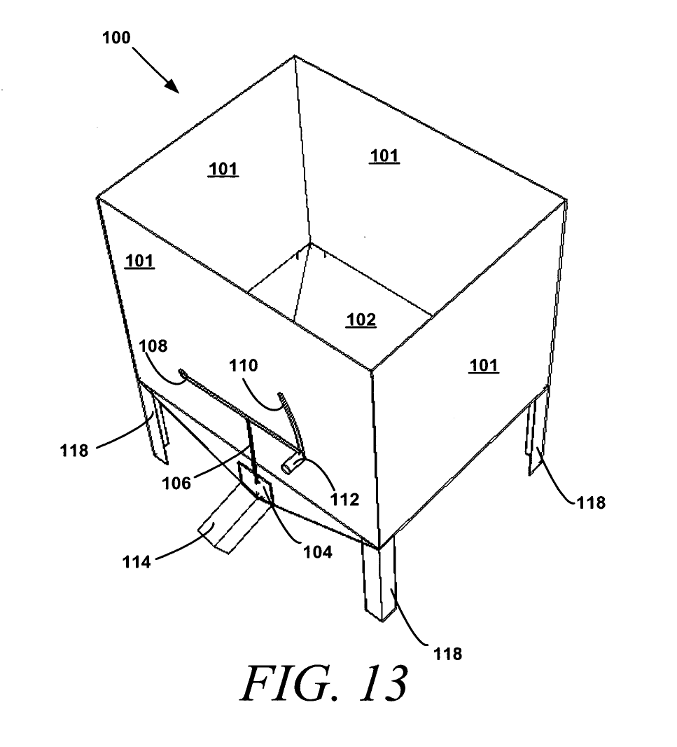

FIGS. 1-8 illustrate several embodiments of the lawn repair device that delivers focused streams of seed and sand mixtures via tilt activation. FIGS. 9-11 illustrate alternate embodiments activated by power sources. The power sources include gas pneumatic, hydro pressure, electric motor assist units or any other appropriate power source fitted to the embodiments illustrated in FIGS. 1-8. FIG. 12 illustrates in cross-section details of the collimating block and aperture plate of the aforementioned embodiments of the lawn repair device. FIGS. 13-15 illustrate an embodiment of a fill hopper used to charge the reservoirs of the lawn repair devices of FIGS. 1-11 with seed and sand or other lawn repair or maintenance materials. The illustrative embodiments of the lawn repair device and fill hopper may be made of molded plastic, fiberglass, metal materials, or any combination thereof.

FIG. 1 is an isometric view depicting an embodiment of the lawn repair device in an at-rest or un-deployed position. The lawn repair device 10 includes a reservoir 12, the reservoir 12 being substantially cylindrical and able to contain a sand and seed mixture. The length and diameter of the reservoir 12 may be varied to hold different volumes of sand and seed mixtures. In this illustration the outside of the reservoir 12 includes a scale 12A having the numbers 6, 9, 12, 15, 18, 21, and 24. The scale numbers represent inches or other equivalent dimensions for estimating the quantity of sand and seed mixtures present in the reservoir 12. Attached to the reservoir 12 is a handle 13. The reservoir 12 is attached to a funnel 14 via a bolt 14A or similar rivets. The funnel 14 is sealed to a channel 16 that in turn is attached to a three-leg support comprising two support legs 22 and a lever assembly 30. The support legs 22 may be attached to the funnel 14, as illustrated, the reservoir 12, or the channel 16. The attachment of the support legs 22 may be by spot welding, rivets, screws, bolts, or other fasteners. The channel 16 includes a slot 18 located on opposite sides of the channel 16.

The channel 16 has a substantially rectangular or square configuration, though it may be cylindrically shaped. Disposed approximately opposite to the attachment points of the support legs 22 is a lever assembly 30. The lever assembly 30 includes a foot pad 36, a first hinge 38, a second hinge 39, a plate 40 having an aperture 42 that slidably fits within slot 18, and a spring 50 that engages against the lever assembly 30 and the side exterior of the channel 16. As illustrated, the plate 40 is curved and slidably moves within the slot 18. In other lawn repair device embodiments the plate 40 may be flat. The lever assembly 30 reversibly articulates about the first hinge 38 attached to the exterior of channel 16. The second hinge 39 is interposed between lever assembly 30 and the curved aperture plate 40. The curved aperture plate 40 may include stops, not shown, to prevent the plate 40 from being expelled from the slot 18 or to regulate the penetration depth of the aperture 42 within the interior space of the channel 16. The coil spring 50 provides tension such that the lawn repair device 10 is normally in an at-rest or stowed status in which the foot pad 36 is positioned as the third tripod leg together with support legs 22 and maintains the reservoir 12 in a substantially vertical orientation and self-standing. The spring 50 is located near the top of the lever assembly 30, and the first hinge 38 is located near the bottom of the lever assembly. Pivoting occurs about the first hinge 38 and spring return from the top via the coil 50. In the self-standing status, the aperture 42 is externally disposed to the channel 16. The at-rest status of the lawn repair device 10 is such that the curved aperture plate establishes a sealed block beneath the funnel 14 such that sand and seed mixtures in the reservoir 12 do not pass into the channel 16. The at-rest status of the lawn repair device 10 is such that the lawn repair device 10 is self-standing via the support stand 20. As shown in the at-rest status condition of the FIG. 1, the second stop is engaged against the exterior side of the channel 16 above the attachment locations of the support legs 22.

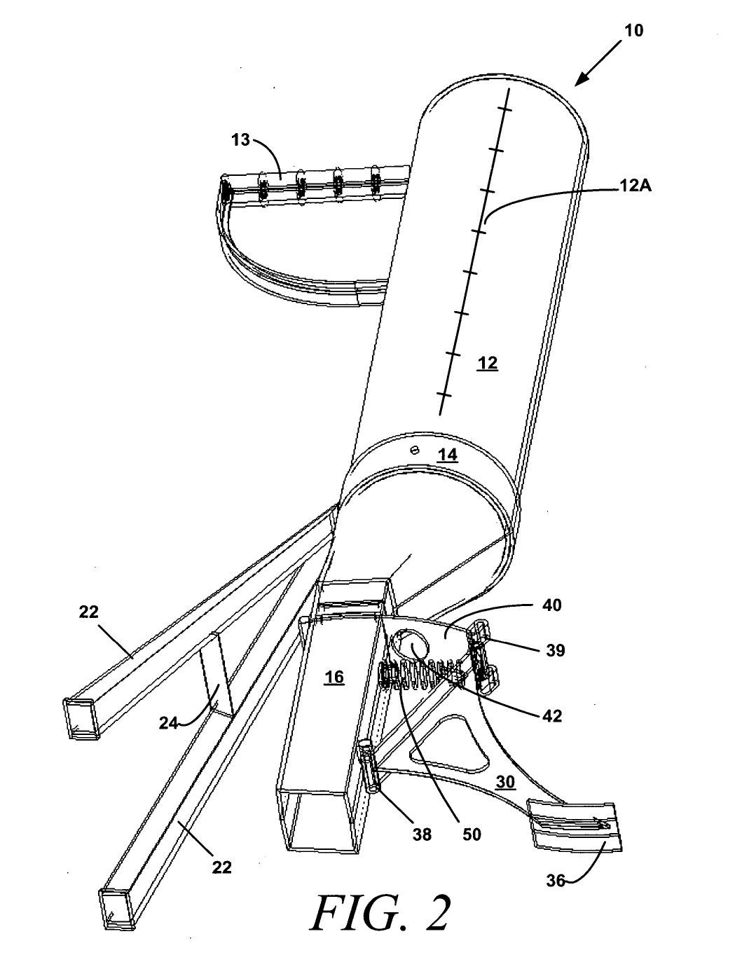

FIG. 2 is an isometric bottom view of the lawn repair device in an at rest status. In this illustration the external location of the aperture 42 is shown in relation to the lever mechanism 30 and channel 16.

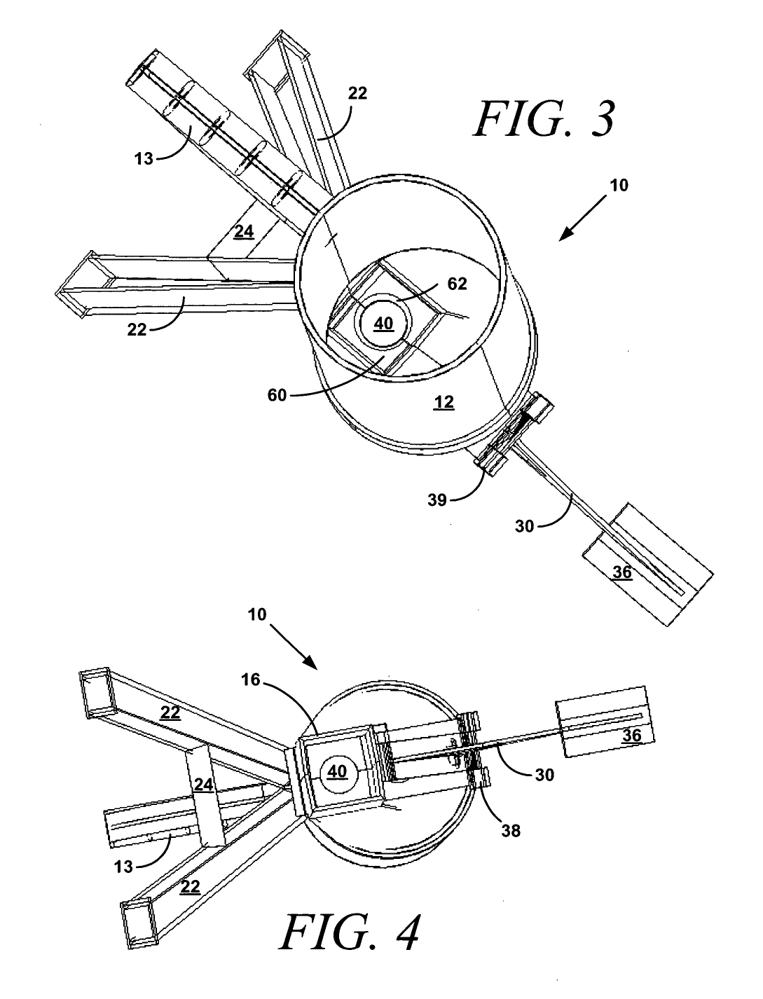

FIG. 3 is an isometric top view of the lawn repair device in an at rest status. At the bottom of internal chamber of the reservoir 12 resides a stream-forming or collimating block 60. The collimating block 60 includes a collimating channel 62 that serves to form the sand and seed mixture in a column or stream to aid in the focused delivery of lawn repair or maintenance materials. The collimating block 60 and channel 62 are illustrated in cross-section in FIG. 12 below. In illustrative embodiments, the block 60 and the collimating channel 62 are approximately 2 inches in length and are cylindrically shaped. At the bottom of the cylindrical wall is a portion of the solid region of the aperture plate 40. When the device 10 is in the at-rest or un-deployed state, the solid portion of the aperture plate 40 is in sealable contact with the collimating block 60 and blocks or spans across the collimating channel 62 such that the seed and sand transit is stopped.

FIG. 4 is another isometric bottom view of the lawn repair device in an at rest status. The substantially rectangular internal region of the channel 16 is shown extending below the solid region of the plate 40.

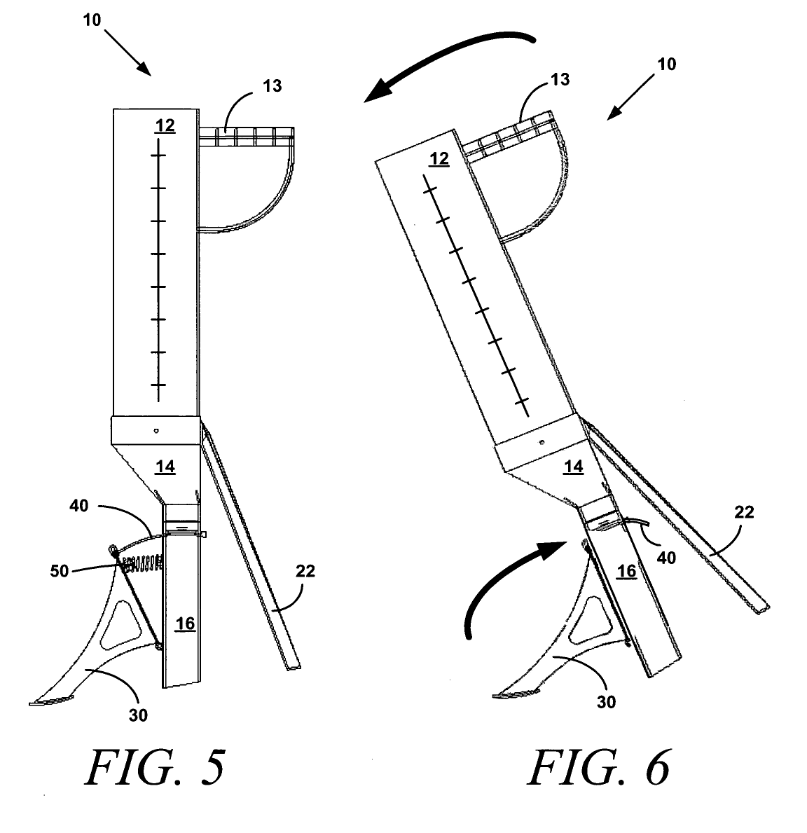

FIG. 5 is a side view of the lawn repair device in an at rest status. Here a good portion of the semicircular plate 40 is shown externally disposed to the channel 16.

FIG. 6 is a side view of the lawn repair device in a deployed status. When the device 10 is tilted in the direction indicated by the upper heavy arrow, the lever assembly 30 is pushed in an opposing direction, compresses or tensions the spring 50, and positions the aperture 42 (not shown) concentrically with the channel 62 internally within the channel 16. Sand and seed or other lawn repair material passes through the colliminating channel 62, through the aperture 42, and out the channel 16 that maintains the colliminated character or the delivered material. Reversing the tilt to the un-deployed state allows the spring 50 to push out the aperture 42 from the internal regions of the channel 16 and shutter or block the delivery of lawn repair material.

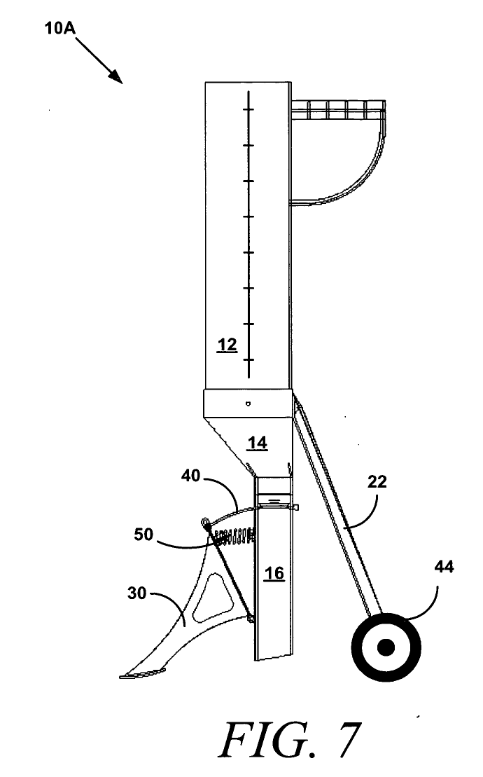

FIG. 7 is a side view of an alternate embodiment of a wheeled lawn repair device 10A in an at rest status. A wheel 44 is attached near the end of the leg 22 to impart convenient mobility without having to lift or tote the lawn repair device 10A.

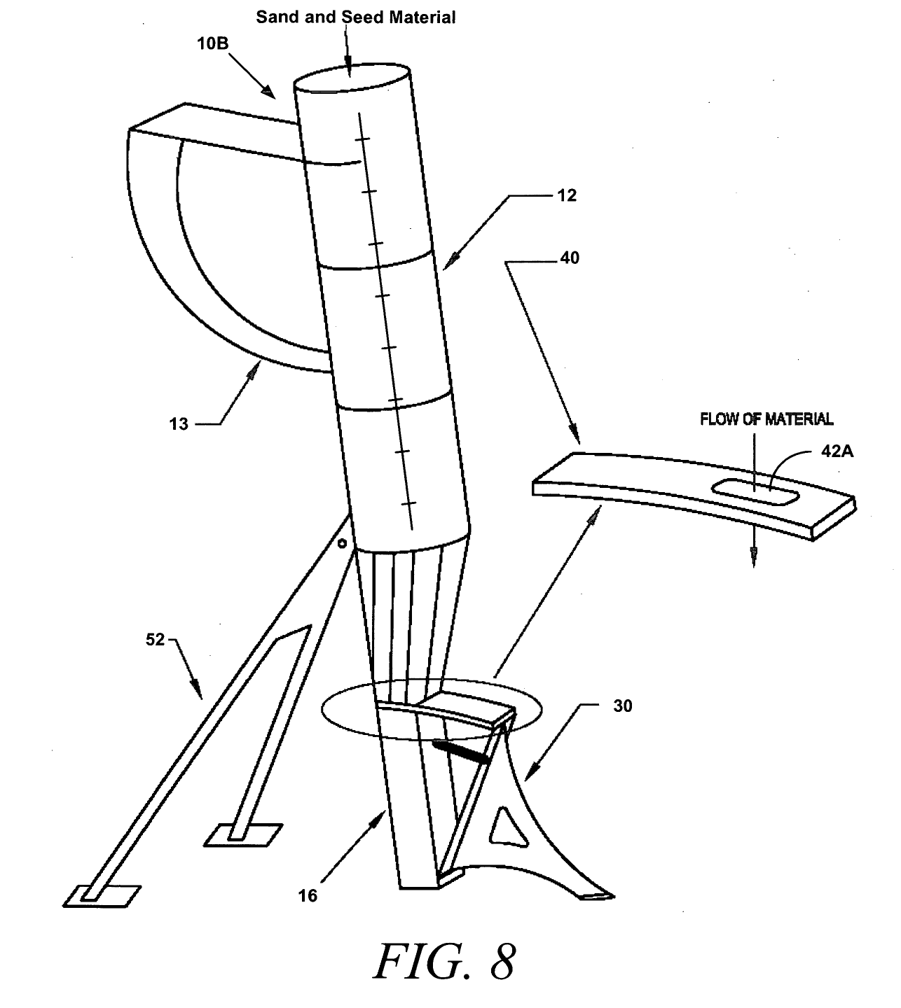

FIG. 8 is an isometric view of another alternate embodiment of the lawn repair device in an at rest status. Substantially similar to the device 10 and 10A, lawn repair device 10B includes a combination split leg 52 and a substantially rectangular aperture 42A. The rectangular aperture 40A permits different rates of material delivery in proportion to the depth the aperture 40A is plunged into the internal region of the channel 16, the rate of plunging, and the aperture size.

FIG. 9 is an isometric view of a lawn repair device 10C with a pneumatic assist 60. The pneumatic assist 60 includes a plunger (not shown) and is mounted on bracket 66. The plunger of pneumatic assist 60 is connected to the aperture plate 40 via linkage 64 and receives gas from air line 62 connected to a gas source (not shown) mountable to the lawn repair device 10C. The aperture plate 40 is thrust inward into the slot 18 (not shown) of channel 16 upon activation via a trigger (not shown) connected with the pneumatic assist 60 to place at least a portion of the aperture 42A in the channel 16. An internal spring (not shown) opposing the plunger's action within the pneumatic assist retracts the aperture 42A of the plate 40 from the internal region of the channel 16 when the trigger is no longer activated. The trigger may be fitted to the handle 13 and include communication lines to the pneumatic assist 60 located on the bracket 66.

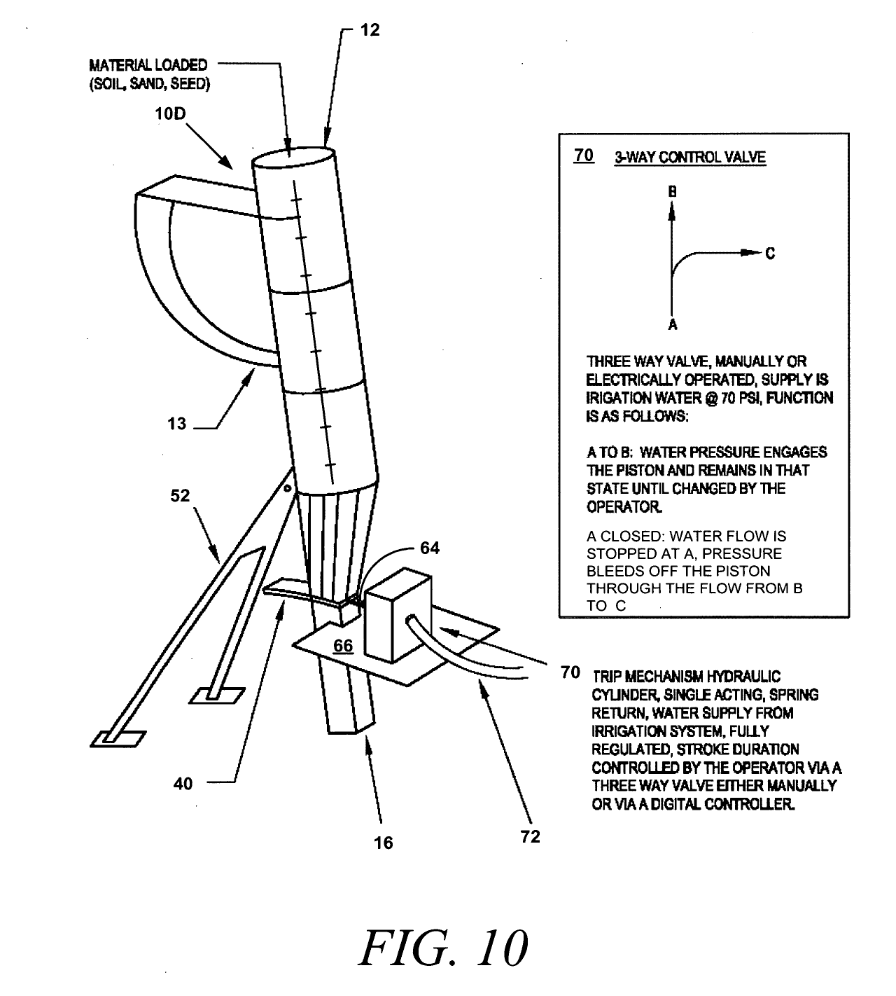

FIG. 10 is an isometric view of an alternate embodiment lawn repair device 10D with a hydraulic assist 70. The hydraulic assist 70 includes a plunger (not shown) and is mounted on bracket 66. The plunger of hydraulic assist 70 is connected to the aperture plate 40 via linkage 64 and receives water from hose 72 connected to a water source (not shown) mountable to the lawn repair device 10D. The aperture plate 40 is thrust inward into the slot 18 (not shown) of channel 16 upon activation via a trigger (not shown) connected with the hydraulic assist 70 to place at least a portion of the aperture 42A in the channel 16. An internal spring (not shown) opposing the plunger's action within the hydraulic assist 70 retracts the aperture 42A of the plate 40 from the internal region of the channel 16 when the trigger is no longer activated. The trigger may be fitted to the handle 13 and include communication lines to the hydraulic assist 70 located on the bracket 66.

The hydraulic assist 70 provides a hydraulic trip mechanism that utilizes a three-way control valve (not shown). The plunger (not shown) is connected with a hydraulic cylinder (not shown) that is single acting and includes a spring return. The stroke duration of the hydraulic assist 70 is controlled by the operator manually operating the three-way control valve (not shown). Alternatively, the three-way control valve may be operated via a digital controller (not shown). A schematic of the hydraulic assist 70 is illustrated in the inset box. The three-way control valve of the hydraulic assist 70 includes ports A, B, and C. The three-way control valve may be manually or electrically operated to supply irrigation water at approximately 70 pounds per square inch (psi). The water flows from port A to port B when water pressure engages the piston (not shown) and remains in that state until changed by the operator's manipulation of the trigger (not shown). Water flows from port B to port C when the water flow ceases and causes air pressure to bleed from the piston (not shown).

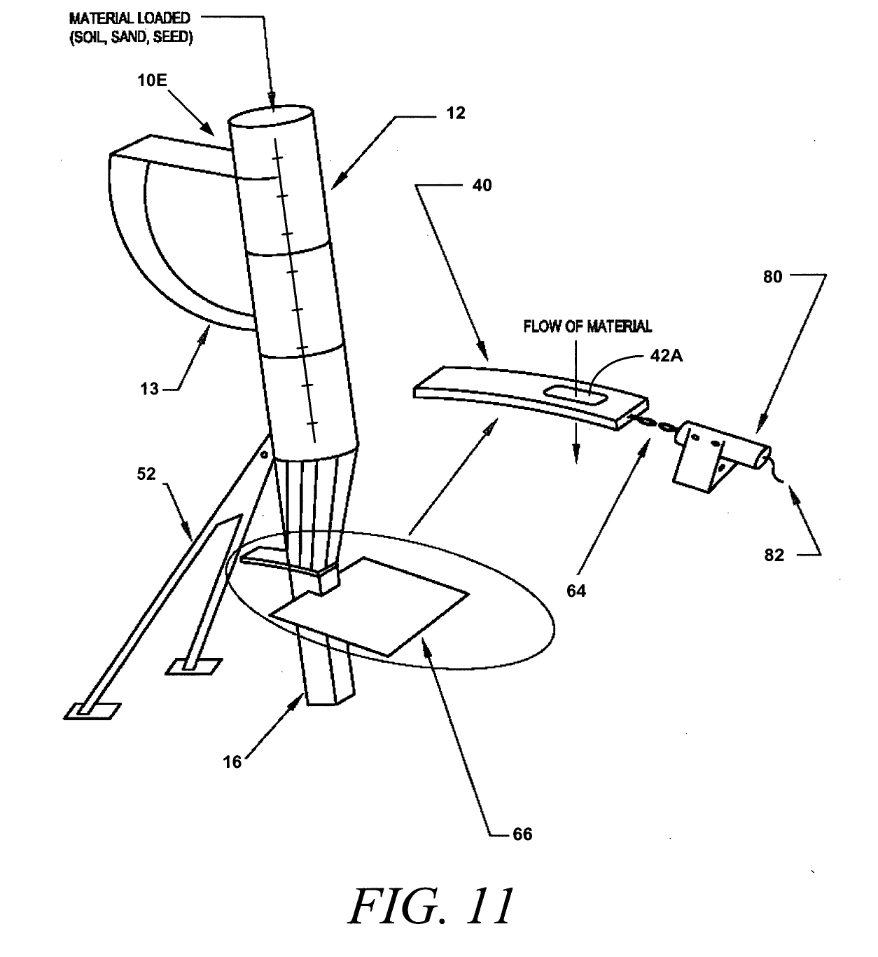

FIG. 11 is an isometric view of an alternate embodiment lawn repair device 10E with an electric assist 80. The electric assist 80 includes a plunger (not shown) and is mounted on bracket 66. The plunger of electric assist 80 is connected to the aperture plate 40 via linkage 64 and receives electrical current from electric conductor 82 connected to an electric source (not shown) mountable to the lawn repair device 10E. The aperture plate 40 is thrust inward into the slot 18 (not shown) of channel 16 upon activation via a trigger (not shown) connected with the electric assist 80 to place at least a portion of the aperture 42A in the channel 16. An internal spring (not shown) opposing the plunger's action within the electric assist 80 retracts the aperture 42A of the plate 40 from the internal region of the channel 16 when the trigger is no longer activated. The trigger may be fitted to the handle 13 and include communication lines to the electric assist 80 located on the bracket 66.

FIG. 12 is a cross-sectional side view of the channel, collimating block and aperture plate region of the aforementioned embodiments 10 and 10A-E of the lawn repair device. The curved aperture plate 40, having either the substantially circular aperture 42 or substantially rectangular aperture 42A slidably moves within the internal chamber of the channel 16. The aperture plate 40 is restrained from complete retraction from the slot 18 by plate stop 41. Beneath the funnel 14, and above the aperture plate 40, is the collimating block 60 with the collimating channel 62. The collimating block 60 is configured to match the sliding surface of the aperture plate 40. In this illustration where the aperture plate 40 is curved, the touching surface of the collimating block 60 is matched in curvature to the curvature of the aperture plate 40, thereby maintaining a sealable engagement. In alternate embodiments when the aperture plate 40 is substantially flat, the touching surface of the collimating block is similarly flat to maintain a sealable engagement with the substantially flat surface of the aperture plate 40. Inward pushing of the aperture plate 40 positions the aperture 42 or 42A beneath the collimating channel 62 to permit passage of lawn maintenance materials from the funnel 14 through the collimating channel 62 and into the inner chamber of the channel 16.

FIG. 13 is an isometric view of an embodiment of a fill hopper 100 for use in conjunction with the aforementioned lawn repair devices 10 and 10A-E to form a lawn repair system. Hopper 100 includes four walls 101, a bottom 102, door 104, lever 106, slots 108 and 110, knob 112, spillway 114, and legs 118. Bottom 102 is scooped or funnel shaped where the bottommost confluence of the scoop faces the door 104. The door 104 is liftable by the lever 106 connected with the door 104. The lever 106 articulates about a substantially horizontal slot 108 cutout in one of the walls 101. Upward lifting is achieved by knob 112 attached to the lever 106 and guided within curved slot 110. The extent that door 106 is lifted is determined by the net vertical movement of the knot 112 traveling within curved slot 110. Sand and seed or other lawn repair materials stored within the chamber defined by the walls 101 and bottom 102 is released from the opening created by the upward movement of the door 106. Repair materials transiting the opening of the door 106 flow along the spillway 114 and into the reservoir 12 of devices 10 or 10A-E.

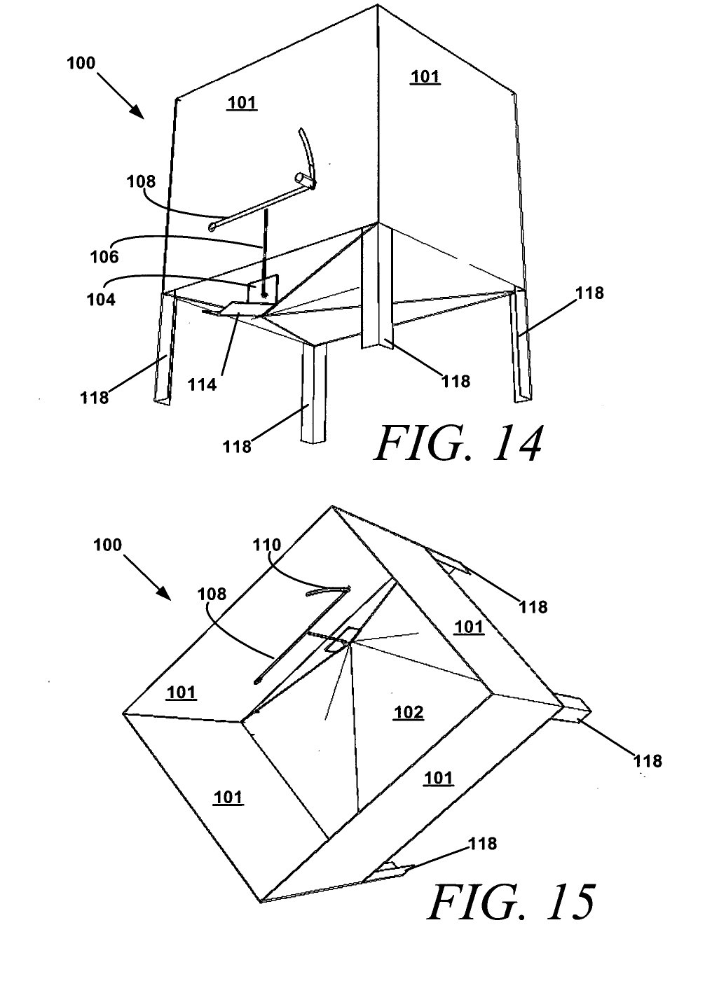

FIG. 14 is a bottom isometric view of the fill hopper 100. The confluence of the funnel shaped bottom 102 with the door 104 is more clearly seen.

FIG. 15 is an internal top isometric view of the fill hopper 100. Again, the confluence of the funnel shaped bottom 102 abutting the door 104 is more clearly seen.

Typical dimensions for aforementioned lawn repair devices 10 and 10A-E, though not restricted to the typical dimensions, include the reservoir 12 having a length of approximately 24 inches and an internal diameter of approximately 5 inches. The internal diameter of approximately 5 inches allows an approximate filling of eighty golf course divots per foot of seed and sand mixtures contained in the reservoir 12. The mouth of the funnel 14 that mates with the cylinder 12 is approximately 5 inches, then converges to a rectangular configuration having a 2 inch by 2 inch square shape when viewed from the side. The channel 16 mates with the converged section of the funnel, and similarly has a 2-inch by 2-inch configuration when viewed from the bottom side. The length of the channel 16 is approximately 12 inches. Approximately 2 inches below the funnel 14 is the slot 18 located on opposing sides of the channel 16. The slot 18 is approximately 1.75 inches wide. The aperture plate 40 is slightly less than 1.75 inches and slidably oscillates between the at-rest or blocked position and the aperture-deployed position. The aperture plate 40 is slightly curved or arched to maintain a seal against the internal walls of the channel 16 so that sand and seed mixtures do not leak from the reservoir 12 when the devices 10-10E are in the self-standing, at-rest position. The aperture 42 of the aperture plate 40 has a diameter of approximately ⅞ inches. The collimating block 60 and the collimating channel 62 may have lengths shorter or greater than 2 inches.

While the preferred embodiment of the invention has been illustrated and described, as noted above, many changes can be made without departing from the spirit and scope of the invention. For example, the cylinder 12 of funnel 14 and the channel 16 of the lawn repair device 10 may be made out of multiple materials including metal and plastics or fiberglass. In particular, the reservoir 12, the funnel 14, and the channel 16 may be unitary construction made from thermo-setting plastics. Moreover, the handle 13 need not be a single cylinder-type handle. It may take the form of a suitcase-like handle that is mounted more in the center position of the cylinder 12 or on the other side of the cylinder 12 so that the lawn repair device may be more readily grasped on each side of the cylinder 12. The open end of the cylinder may also be fitted with a lid. Moreover, the embodiments described for the lawn repair device is not limited to delivering lawn maintenance materials. For example, the embodiments of the aforementioned lawn repair device may be used for delivery of other fluidized materials for purposes other than lawn repair. Other fluidized materials deliverable by the lawn repair devices include agricultural supplies for development of plant crops, gravel supplies for path maintenance, chalk for playfield markings, or road materials for road maintenance. In conjunction with these other uses for the lawn repair devices, the hopper may similarly be used for filling the reservoirs of the lawn repair devices with fluidized materials other than lawn maintenance materials. Accordingly, the scope of the invention is not limited by the disclosure of the aforementioned exemplary embodiments. Instead, the invention should be determined entirely by reference to the claims that follow.

The embodiments of the invention in which an exclusive property or privilege is claimed are defined as follows:

1. A lawn repair device comprising:
a reservoir configured to receive lawn maintenance materials;
a channel member attached with the reservoir, the channel having a slot;
a lever assembly engageable with the channel; and
a plate having an aperture and engageable with the lever assembly;
wherein tilting of the reservoir causes the lever assembly to move the aperture through the slot and inside the channel to permit the passage of seed and sand mixtures through the channel.

2. The device of claim 1, wherein the channel member further includes a collimating block to form the lawn maintenance materials into streams.

3. The device of claim 2, wherein the plate is in sealable contact with the collimating block while the device is not tilted to block passage of the lawn maintenance materials.

4. The device of claim 2, wherein tilting results in the plate to position the aperture beneath the collimating block to allow passage of the lawn maintenance materials.

5. The device of claim 1, further comprises a stand.

6. The device of claim 5, wherein the stand includes at least one wheel.

7. A lawn repair device comprising:
a reservoir configured to receive lawn maintenance materials;
a trigger;
a channel member attached with the reservoir, the channel having a slot;
a plate having an aperture and engageable with the slot; and
a piston connected with the aperture plate and having a power source, the power source being controlled by the trigger,
wherein pressing the trigger activates the power source to engage the piston and move the aperture into the slot and inside the channel member to release the lawn maintenance materials from the channel member.

8. The device of claim 7, wherein the power source includes at least one of an electric motor, a compressed gas, and a pressurized fluid.

9. The device of claim 8, wherein the channel further includes a collimating block to form the lawn maintenance materials into streams.

10. The device of claim 9, wherein the plate is in sealable contact with the collimating block while the trigger is not pressed to block passage of the lawn maintenance materials.

11. The device of claim 6, wherein the trigger is connected with the reservoir

12. The device of claim 7, further comprises a stand.

13. The device of claim 12, wherein the stand includes at least one wheel.

14. A lawn repair system comprising:
a dispenser configured to deliver lawn maintenance materials;
a lawn repair device having:
a reservoir configured to hold the lawn maintenance materials received from the dispenser;
a funnel attached with the reservoir;
a channel member having a slot and attached with the funnel;
a stand attached with the channel;
a plate having an aperture, the plate being slidably and sealably engageable with the channel; and
a lever assembly engageable with the plate,
wherein moving the lever assembly transfers the plate through the slot and positions the aperture inside the channel member to permit the passage of the lawn maintenance materials from the reservoir.

15. The system of claim 14, wherein the lever assembly is moved by tilting the lawn repair device.

16. The system of claim 14, wherein the lever assembly includes a piston connected with a power source.

17. The system of claim 16, wherein the power source includes at least one of an electric motor, a compressed gas, and a pressurized fluid.

18. The system of claim 14, wherein the lever assembly further includes a switch connectable with the power source.

19. The system of claim 18, wherein the lever assembly is moved by the piston receiving power from the power source through engagement by the switch.

20. The system of claim 14, wherein the channel member further includes a collimating block to form seed and sand mixtures into streams.

21. The system of claim 14, wherein the dispenser includes:
a chamber to hold the seed and sand mixtures;
a door located approximately at the bottom of the chamber;
a lever connected with the door; and
a spillway having a first end connected with the bottom of the door and a second end overlapping the entrance to the reservoir of the lawn repair device,
wherein moving the lever creates a door opening permitting the delivery of the lawn maintenance materials from the chamber, through the door opening, across the spillway, and into the reservoir.

22. The system of claim 21, wherein the lever includes a knob.

23. The system of claim 22, wherein the chamber includes a slotted pathway slidably engageable with the knob such that the size of the door opening is determined by the position of the knob within the slotted pathway.

24. The system of claim 23, wherein the slotted pathway is curved.
